(19) United States
(12) Patent Application Publication
(10) Pub. No.: US 2019/0097814 A1
(43) Pub. Date: Mar. 28, 2019

(54) METHOD AND APPARATUS FOR APPLICATION AUTHENTICATION

(71) Applicant: GM GLOBAL TECHNOLOGY OPERATIONS LLC, Detroit, MI (US)

(72) Inventors: Ramie Phillips, III, Rochester HIlls, MI (US); Thomas M. Forest, Macomb, MI (US); Yuval Polevoy, West Bloomfield, MI (US); Karl B. Leboeuf, Windsor (CA); Evripidis Paraskevas, Royal Oak, MI (US)

(21) Appl. No.: 15/718,228

(22) Filed: Sep. 28, 2017

(51) Int. Cl. H04L 9/32; G06F 21/44; H04L 9/14; H04L 9/30

(52) U.S. Cl. CPC H04L 9/3263; H04L 9/30; H04L 9/14; G06F 21/44

(57) ABSTRACT

A method and apparatus that authenticate an application are provided. The method includes connecting an authentication application on the first device to a second application of a second device on a second address and port in response to receiving a first request on a first address and port from the second application, receiving a second request including a signed certificate of the second device, determining whether the signed certificate is valid, in response to determining the signed certificate is valid, displaying a screen to accept request if the signed certificate is unapproved, and performing a function if the request is accepted.

### INTRODUCTION

Apparatuses and methods consistent with exemplary embodiments relate to authenticating an application. More particularly, apparatuses and methods consistent with exemplary embodiments relate to authenticating a first application on a remote device to communicate with a second application on a local device.

### SUMMARY

One or more exemplary embodiments provide a method and an apparatus that provides secure access between an application on a remote device such as a mobile device and an application on a local device such as center stack module. More particularly, one or more exemplary embodiments provide a method and an apparatus that include an authentication or network broker application that provides secure access between an application on a mobile device and an application on a center stack module.

According to an aspect of an exemplary embodiment, a method for authenticating an application is provided. The method includes detecting an input to enter an enrollment mode on a first device and entering into enrollment mode for a predetermined period of time, during the predetermined period of time, connecting an authentication application on the first device to a second application of a second device on a second address and port in response to receiving a first request on a first address and port from the second application, receiving a second request including a signed certificate of the second device, determining whether the signed certificate is valid, in response to determining the signed certificate is valid, displaying a screen to accept request if the signed certificate is unapproved, and storing request if the request is accepted.

The second request including the signed certificate may include one or more from among user identification information, application identification information, a requested service name, a requested service port, a certificate of the second device, and a public key of the second device.

The connecting the authentication application on the first device to the second application of the second device on the second address and port in response to receiving the first request on the first address and port from the second application may include responding to the request by providing the second address and port to the second application.

The first request on the first address and port from the second application may include a multicast domain name system (mDNS) request and the first address and port may be a UDP rate limited port. In addition, the second address and port may be a TCP rate limited port.

The screen to accept the request may include include a first option to always accept a connection from the second application, a second option to accept a connection from the second application for the received request, and a third option to deny a connection from the second application for the received request.

According to an aspect of an exemplary embodiment, a method for authenticating an application is provided. The method includes connecting an authentication application on a first device to a second application of a second device on a second address and port in response to receiving a first request on a first address and port from the second application, receiving a second request including a signed certificate of the second device, determining whether the signed certificate is valid, in response to determining the signed certificate is valid, displaying a screen to accept request if the signed certificate is unapproved, sending a first encrypted random number and a second encrypted random number to the first application on the first device and the second application on the second device, receiving, by the authentication application, a first hash of the decrypted first random number and a first shared predefined context string, verifying the received first hash at the authentication application, and closing a firewall sync port if the verifying the received first hash fails or opening a requested TLS port if the verifying the received first hash is successful.

The method may also include receiving, by the first application, a second hash of the second decrypted random number and a second shared predefined context string, verifying the second hash at the first application, and setting up a TLS PSK based on the verified second hash and the second random number.

The second request including the signed certificate may include one or more from among user identification information, application identification information, a requested service name, a requested service port, a certificate of the second device, and a public key of the second device.

The first request on the first address and port from the second application may include and a multicast domain name system (mDNS) request, and the first address and port may include a UDP rate limited port and the second address and port comprises a TCP rate limited port.

The connecting the authentication application on the first device to the second application of the second device on the second address and port in response to receiving the request on the first address and port from the second application may include responding to the request by providing the second address and port to the second application.

The screen to accept the request may include a first option to always accept a connection from the second application, a second option to accept a connection from the second application for the received request, and a third option to deny a connection from the second application for the received request.

According to an aspect of an exemplary embodiment, an apparatus that authenticates an application is provided. The apparatus includes: at least one memory comprising computer executable instructions and at least one processor configured to read and execute the computer executable instructions. The computer executable instructions cause the at least one processor to connect an authentication application on a first device to a second application of a second device on a second address and port in response to receiving a first request on a first address and port from the second application, receive a second request including a signed certificate of the second device, determine whether the signed certificate is valid, in response to determining the signed certificate is valid, display a screen to accept request if the signed certificate is unapproved, and perform a function if the request is accepted.

The computer executable instructions may cause the at least one processor to perform the function if the request is accepted by storing the request.

The computer executable instructions may cause the at least one processor to perform the function if the request is accepted by: sending a first encrypted random number and a second encrypted random number to the first application on the first device and the second application on the second device; receiving, by the authentication application, a first hash of the decrypted first random number and a first shared predefined context string; verifying the received first hash at the authentication application; and closing a firewall sync port if the verifying the received first hash fails or opening a requested TLS port if the verifying the received first hash is successful.

The computer executable instructions cause the at least one processor to perform the function if the request is accepted by: receiving, by the first application, a second hash of the second decrypted random number and a second shared predefined context string; verifying the second hash at the first application; and setting up a TLS PSK based on the verified second hash and the second random number.

The request including the signed certificate may include one or more from among user identification information, application identification information, a requested service name, a requested service port, a certificate of the second device, and a public key of the second device.

The computer executable instructions may cause the at least one processor to connect the authentication application on the first device to the second application of the second device on the second address and port in response to receiving the request on the first address and port from the second application by responding to the request by providing the second address and port to the second application.

The screen to accept the request may include a first option to always accept a connection from the second application, a second option to accept a connection from the second application for the received request, and a third option to deny a connection from the second application for the received request.

The request on the first address and port from the second application may include a multicast domain name system (mDNS) request, and the first address and port may be a UDP rate limited port and the second address and port comprises a TCP rate limited port.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 shows a block diagram of an apparatus that authenticates an application according to an aspect of an exemplary embodiment;

FIG. 2 shows a block diagram of an apparatus that authenticates an application according to an aspect of an exemplary embodiment;

FIG. 3 shows a diagram of a system that authenticates an application according to an exemplary embodiment;

FIG. 4 shows a flow diagram of authenticating an application according to another exemplary embodiment;

FIG. 5 shows a flow diagram of authenticating an application according to another exemplary embodiment; and

FIG. 6 shows a flowchart for a method of authenticating an application according to an exemplary embodiment.

### DETAILED DESCRIPTION OF EXEMPLARY EMBODIMENTS

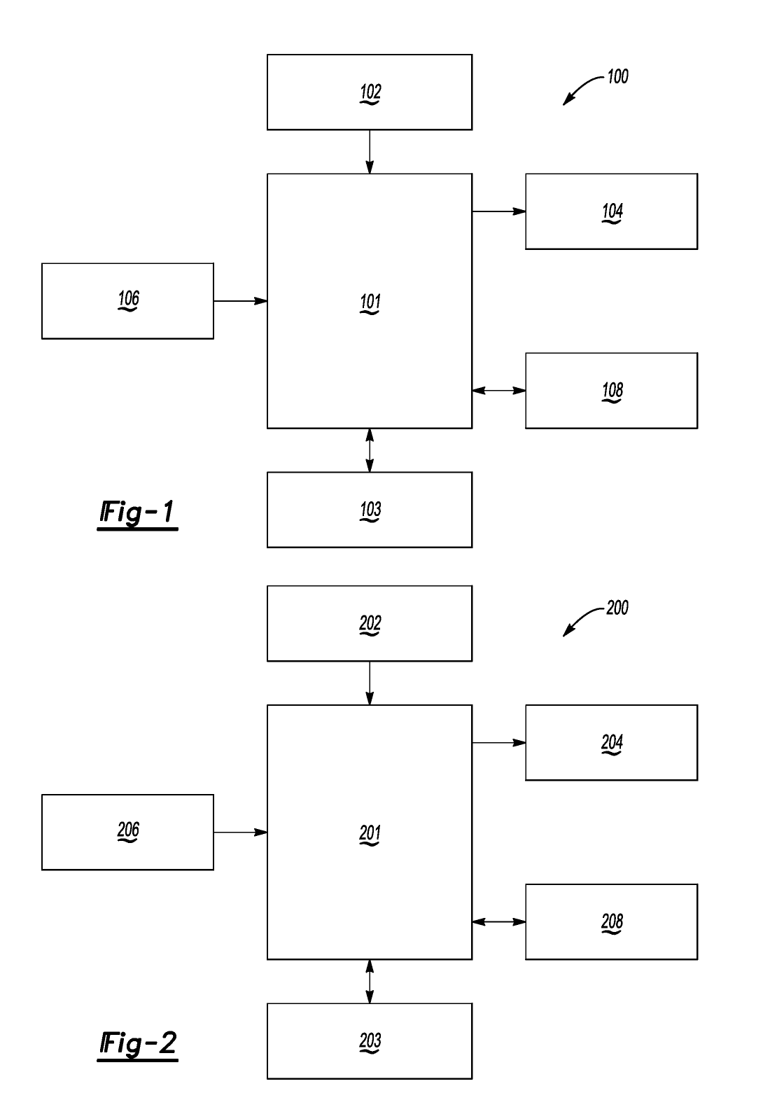

An apparatus and method that authenticate an application will now be described in detail with reference to FIGS. 1-6 of the accompanying drawings in which like reference numerals refer to like elements throughout.

The following disclosure will enable one skilled in the art to practice the inventive concept. However, the exemplary embodiments disclosed herein are merely exemplary and do not limit the inventive concept to exemplary embodiments described herein. Moreover, descriptions of features or aspects of each exemplary embodiment should typically be considered as available for aspects of other exemplary embodiments.

It is also understood that where it is stated herein that a first element is “connected to,” “attached to,” “formed on,” or “disposed on” a second element, the first element may be connected directly to, formed directly on or disposed directly on the second element or there may be intervening elements between the first element and the second element, unless it is stated that a first element is “directly” connected to, attached to, formed on, or disposed on the second element. In addition, if a first element is configured to “send” or “receive” information from a second element, the first element may send or receive the information directly to or from the second element, send or receive the information via a bus, send or receive the information via a network, or send or receive the information via intermediate elements, unless the first element is indicated to send or receive information “directly” to or from the second element.

Throughout the disclosure, one or more of the elements disclosed may be combined into a single device or into one or more devices. In addition, individual elements may be provided on separate devices.

Vehicles and other machines now include various devices such as infotainment systems, tablets, computers, radios that run applications. The aforementioned devices or similar devices may connect wirelessly with another device such as a remote device or a mobile device to exchange information over a wireless connection or wireless network. In one instance, an application running on an infotainment system of a vehicle must exchange information with an application running on the remote or mobile device.

Moreover, it is desirable that the wireless connection between the infotainment system and the mobile device be secure and/or that mobile device be authenticated prior to exchanging information to insure that the infotainment system does not receive information from or transmit information to an unwanted devices. To address this above issue, a method of authenticating the mobile device using a backend may be implemented prior to opening a connection to exchange information with the mobile device. The authentication may be performed using a backend server that connects to both the mobile device and the vehicle device or infotainment system.

FIG. 1 shows a block diagram of an apparatus that authenticates an application 100 according to an aspect of an exemplary embodiment. As shown in FIG. 1, the apparatus that authenticates an application 100, according to an exemplary embodiment, includes a controller 101, a power supply 102, a storage 103, an output 104, a user input 106, and a communication device 108. However, the apparatus that authenticates an application 100 is not limited to the aforementioned configuration and may be configured to include additional elements and/or omit one or more of the aforementioned elements. The apparatus that authenticates an application 100 may be implemented as part of a vehicle, as a standalone component, as a hybrid between an on vehicle and off vehicle device, or in another computing device.

The controller 101 controls the overall operation and function of the apparatus that authenticates an application 100. The controller 101 may control one or more of a storage 103, an output 104, a user input 106, and a communication device 108 of the apparatus that authenticates an application 100. The controller 101 may include one or more from among a processor, a microprocessor, a central processing unit (CPU), a graphics processor, Application Specific Integrated Circuits (ASICs), Field-Programmable Gate Arrays (FPGAs), state machines, circuitry, and a combination of hardware, software and firmware components.

The controller 101 is configured to send and/or receive information from one or more of the storage 103, the output 104, the user input 106, and the communication device 108 of the apparatus that authenticates an application 100. The information may be sent and received via a bus or network, or may be directly read or written to/from one or more of the storage 103, the output 104, the user input 106, and the communication device 108 of the apparatus that authenticates an application 100. Examples of suitable network connections include a controller area network (CAN), a media oriented system transfer (MOST), a local interconnection network (LIN), a local area network (LAN), wireless networks such as Bluetooth and 802.11, and other appropriate connections such as Ethernet.

The power supply 102 provides power to one or more of the controller 101, the storage 103, the output 104, the user input 106, and the communication device 108, of the apparatus that authenticates an application 100. The power supply 102 may include one or more from among a battery, an outlet, a capacitor, a solar energy cell, a generator, a wind energy device, an alternator, etc.

The storage 103 is configured for storing information and retrieving information used by the apparatus that authenticates an application 100. The information may include application information sent/received by applications running on the apparatus that authenticates an application 100, authentication information used to authenticate an application, etc. The storage 103 may also include the computer instructions configured to be executed by a processor to perform the functions of the apparatus that authenticates an application 100.

The authentication information may include a signed certificate and one or more from among user identification information, application identification information, a requested service name, a requested service port, a certificate of the second device, and a public key of the second device.

The storage 103 may include one or more from among floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, cache memory, and other type of media/machine-readable medium suitable for storing machine-executable instructions.

The output 104 outputs information in one or more forms including: visual, audible and/or haptic form. The output 104 may be controlled by the controller 101 to provide outputs to the user of the apparatus that authenticates an application 100. In addition, the output 104 may include one or more from among a speaker, an audio device, a display, a centrally-located display, a head up display, a windshield display, a haptic feedback device, a vibration device, a tactile feedback device, a tap-feedback device, a holographic display, an instrument light, an indicator light, etc. The outputs provided to the user may be outputs generated when executing an application.

In one example, the output 104 may display screen to accept request to connect to an application that had not been previously approved or that approval of the connection request is not stored in storage. The screen may include buttons, icons or other graphical features that may be selected using the user input 104. The graphical features may represent one or more from among a first option to always accept a connection from the application, a second option to accept a connection from second application for the received request, and a third option to deny a connection from the application for the received request.

The user input 106 is configured to provide information and commands to the apparatus that authenticates an application 100. The user input 106 may be used to provide user inputs, etc., to the controller 101. The user input 106 may include one or more from among a touchscreen, a keyboard, a soft keypad, a button, a motion detector, a voice input detector, a microphone, a camera, a trackpad, a mouse, a touchpad, etc. The user input 106 may be configured to receive a user input to enter information that is processed by an application.

The communication device 108 may be used by the apparatus that authenticates an application 100 to communicate with various types of external apparatuses according to various communication methods. The communication device 108 may be used to send/receive information including application information of an application running on the apparatus that authenticates an application 100 or a second application running on remote device. The communication device 108 may also be used to send/receive authentication information used to authenticate applications running the apparatus that authenticates an application 100 or a remote device.

The communication device 108 may include various communication modules such as one or more from among a telematics unit, a broadcast receiving module, a near field communication (NFC) module, a GPS receiver, a wired communication module, or a wireless communication module. The broadcast receiving module may include a terrestrial broadcast receiving module including an antenna to receive a terrestrial broadcast signal, a demodulator, and an equalizer, etc. The NFC module is a module that communicates with an external apparatus located at a nearby distance according to an NFC method. The GPS receiver is a module that receives a GPS signal from a GPS satellite and detects a current location. The wired communication module may be a module that receives information over a wired network such as a local area network, a controller area network (CAN), or an external network. The wireless communication module is a module that is connected to an external network by using a wireless communication protocol such as IEEE 802.11 protocols, WiMAX, Wi-Fi or IEEE communication protocol and communicates with the external network. The wireless communication module may further include a mobile communication module that accesses a mobile communication network and performs communication according to various mobile communication standards such as 3^{rd} generation (3G), 3^{rd} generation partnership project (3GPP), long-term evolution (LTE), Bluetooth, EVDO, CDMA, GPRS, EDGE or ZigBee.

According to an exemplary embodiment, the controller 101 of the apparatus that authenticates an application 100 may be configured to receive a request including a signed certificate of the second device, determine whether the signed certificate is valid, in response to determining the signed certificate is valid, display a screen to accept request if the signed certificate is unapproved, and perform a function if the request is accepted.

According to an exemplary embodiment, the controller 101 of the apparatus that authenticates an application 100 may be configured to detect an input to an enter an enrollment mode on a first device and entering into enrollment mode for a predetermined period of time, during the predetermined period of time, connect an authentication application on the first device to a second application of a second device on a second address and port in response to receiving a request on a first address and port from the second application, receive a request including a signed certificate of the second device, determine whether the signed certificate is valid, in response to determining the signed certificate is valid, display a screen to accept request if the signed certificate is unapproved, and store request if the request is accepted.

According to an exemplary embodiment, the controller 101 of the apparatus that authenticates an application 100 may be configured to connect an authentication application on the first device to a second application of a second device on a second address and port in response to receiving a request on a first address and port from the second application, receive a request including a signed certificate of the second device, determine whether the signed certificate is valid, in response to determining the signed certificate is valid, displaying a screen to accept request if the signed certificate is unapproved, send a first encrypted random number and a second encrypted random number to the first application on the first device and the second application on the second device, receive, by the authentication application, a first hash of the decrypted first random number and a first shared predefined context string, verify the received first hash at the authentication application, and close the firewall sync port if the verifying the received hash fails or open a requested TLS port if the verifying the received hash is successful.

According to an exemplary embodiment, the controller 101 of the apparatus that authenticates an application 100 may be configured to the connect the authentication application on the first device to a second application of a second device on the second address and port in response to receiving the request on the first address and port from the second application comprises responding to the request by providing the second address and port to the second application.

The controller 101 may also be configured to receive, by the first application, a second hash of the second decrypted random number and a second shared predefined context string, verify the second hash at the first application; and set up a TLS PSK based on the verified second hash and the second random number.

The request on the first address and port from the second application may be a multicast domain name system (mDNS) request on a user datagram protocol (UDP) rate limited port. The second address and port may be a TCP rate limited port.

FIG. 2 shows a block diagram of a second apparatus that according to another aspect of an exemplary embodiment. As shown in FIG. 2, the second apparatus 200 includes a controller 201, a power supply 202, a storage 203, an output 204, a user input 206, and a communication device 208. However, the second apparatus 200 is not limited to the aforementioned configuration and may be configured to include additional elements and/or omit one or more of the aforementioned elements.

The second apparatus 200 may be embodied as mobile device, portable computing device, tablet, smartphone, laptop, etc. In addition, controller 201, power supply 202, storage 203, output 204, user input 206, and communication device 208 are similar to controller 101, power supply 102, storage 103, output 104, user input 106, and communication device 108, respectively, perform similar functions, and contain similar components. Thus, repeated descriptions of these elements are omitted.

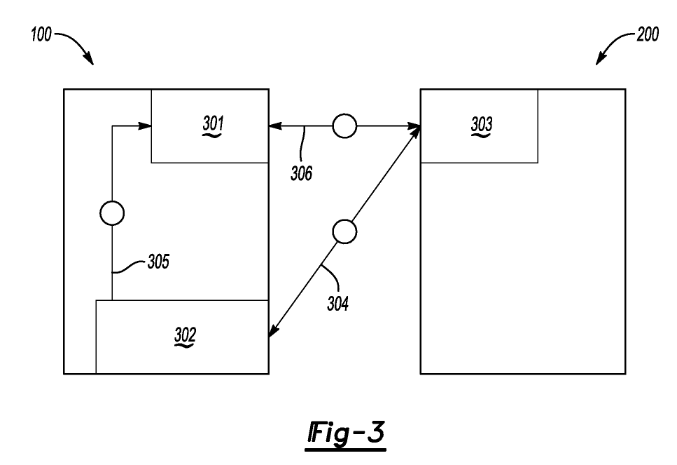

FIG. 3 shows a diagram of a system that authenticates an application according to an exemplary embodiment.

Referring to FIG. 3, a second application 303 running on a second apparatus that authenticates an application 200 connects to an authenticator and network broker application 302 running on the first apparatus that authenticates an application 100 in operation 304. In this example, the second apparatus that authenticates an application 200 may be a smartphone or other mobile device and the first apparatus that authenticates an application 100 may be a center stack module or infotainment system.

The authenticator and network broker application 302 authenticates the second application 303 using a backend server and instructs first application 301 running on a first apparatus that authenticates an application 100 to open a connection with second application 303 running on a second apparatus that authenticates an application 200 in operation 305. In operation 306, the second application 303 and first application 301 exchange information over the newly opened connection.

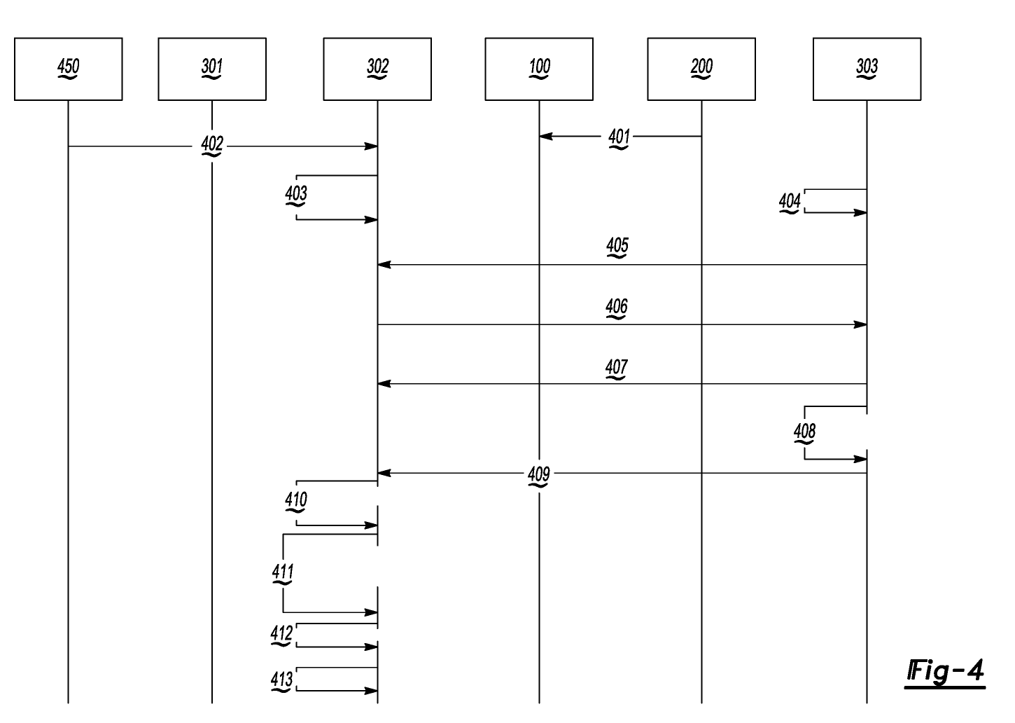

FIG. 4 shows a flow diagram of authenticating an application according to another exemplary embodiment. The method of FIG. 4 may be performed by the apparatuses that authenticate an application 100 and 200 or may be encoded into a computer readable medium as instructions that are executable by a computer to perform the method.

Referring to FIG. 4, a first example of the flow of operation and information between an operator 450, a first application 301 and a second application 302 on the first apparatus that authenticates an application 100, and a third application 303 on a second apparatus that authenticates an application 200 during an enrollment process is shown. In this instance, the first application 301 may be a consumer facing application running on the first apparatus that authenticates an application 100, the second application 303 may be a network broker and authentication application running on the first apparatus that authenticates an application 100, and the third application 303 may be consumer application running on the second apparatus that authenticates an application 200. The first apparatus that authenticates an application 100 may be an infotainment system or center stack module. The second apparatus that authenticates an application 200 may be a mobile device such as a smartphone.

In FIG. 4, the second apparatus that authenticates an application 200 may connect to the first apparatus that authenticates an application 100 via a wireless communication network such as Wi-Fi network in operation 401. In addition, an operator 450 may press a button to enter the first apparatus that authenticates an application 100 into an enrollment mode in operation 402 thereby causing the second application 302 to enter into enrollment mode for a predetermined period of time in operation 403.

During the predetermined period of time, the third application 303 may be open and running on the second apparatus 200 in operation 404. In operation 405, the second application 302 receives an mDNS request on a UDP rate limited port from the third application 303. In operation 406, the second application responds to the mDNS advertising authentication service, an IP address, service and transmission control protocol (TCP) connection information. In operation 407, the second application 302 connects to the third application 303 over the TCP connection in advertised by the mDNS response.

The third application 303 initiates a public/private key pair and then signs information using the private key and sends a public key with the signed certificate in operation 408. The second application 302 then receives a request including a signed certificate of the third application 303 in operation 409. The signed certificate may include one or more from among user identification information, application identification information, a requested service name, a requested service port, a certificate of the second device, and a public key of the second device.

In operation 410, the second application 302 determines whether the signed certificate is valid by checking whether the signed certificate has been signed by the back office. In response to determining the signed certificate is valid, a screen to accept request is display in operation 411 if the signed certificate is unapproved. For example, if the certificate has never been approved by the second application or a previously approval of the second application has expired. The request to connect is then validated in operation 412 and stored in operation 413. The stored information may be used to by to determine application approval in future requests.

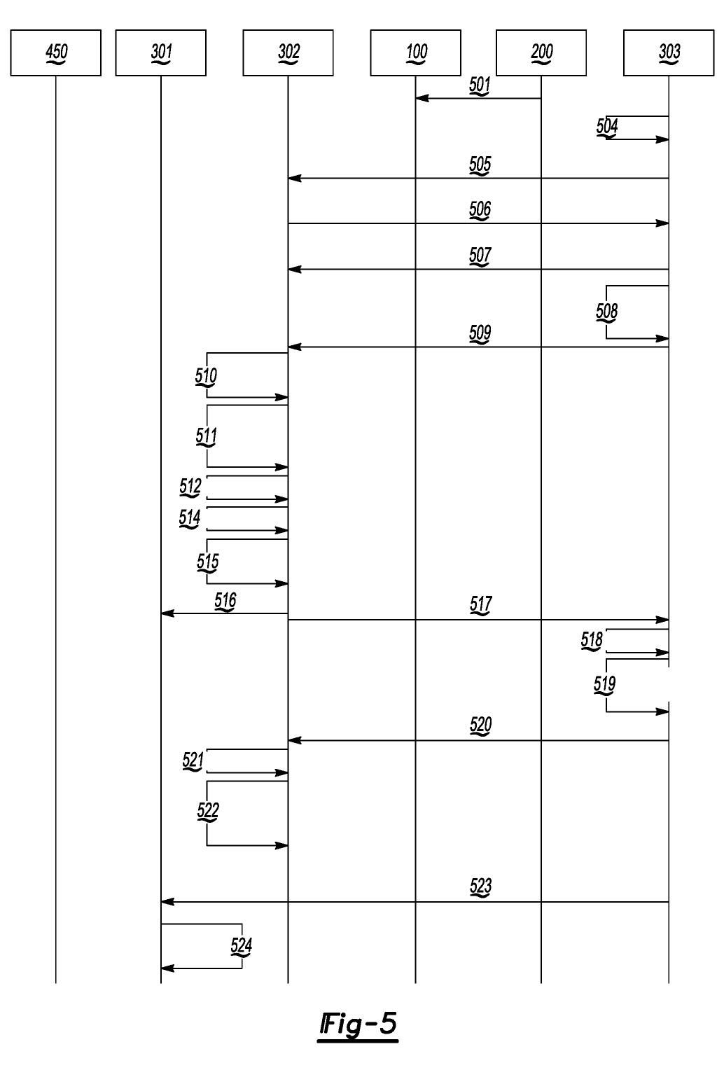

FIG. 5 shows a flow diagram of authenticating an application according to another exemplary embodiment. The method of FIG. 5 may be performed by the apparatuses that authenticate an application 100 and 200 or may be encoded into a computer readable medium as instructions that are executable by a computer to perform the method.

Referring to FIG. 5, a second first example of the flow of operation and information between an operator, a first application and a second on the first apparatus that authenticates an application, and a third application on a second apparatus that authenticates an application during an execution process is shown. The operator, the first application and second application on the first apparatus that authenticates an application, and the third application on a second apparatus that authenticates an application are similar to those described above with respect to FIG. 1-4. Thus, repeated descriptions are omitted. In addition, operations 501 and 504-511 are similar to operations 401 and 404-411. Thus, repeated descriptions of operations 501 and 504-511 are omitted as well.

In operation 512, it is determined whether the request of third application 303 is valid. If the request is invalid, the process reverts to the enrollment process. However, if the request is valid, the process continues to operation 514. In operation 514, two unique random numbers are generated by the second application 302 and are encrypted in operation 515. The second random number is sent to the first application 301 by the second application 302 in operation 516. In operation 517, the first random number and the second random number are encrypted using the third application's public key and sent to the third application 303 with a certificate of first apparatus by the second application 302, signed by the back office.

The third application 303 validates the certificate of first apparatus by checking if it signed by the back office in operation 518. If it is not signed by the back office, the certificate is rejected by the third application. If it is signed by the back office, the encrypted first and second random numbers are decrypted using a private key of third application 303 in operation 519 and a first hash of the decrypted first random number and a first shared predefined context string is sent to second application in operation 520.

In operation 521, the second application 302 verifies the received first hash and if verification fails, the firewall synchronization port is actively closed. If verification succeeds, a requested transport layer security (TLS) port is opened in operation 522 for a predetermined period of time (e.g., sixty seconds) as defined in a certificate presented at enrollment.

If TLS pre-shared key (PSK) does not follow operation 522, the first application 301 receives a second hash of the second decrypted random number and a second shared predefined context string in operation 523. Then, in operation 524, the second hash is verified by the first application 301 and a TLS PSK connection is set up based on the verified second hash and the second random number.

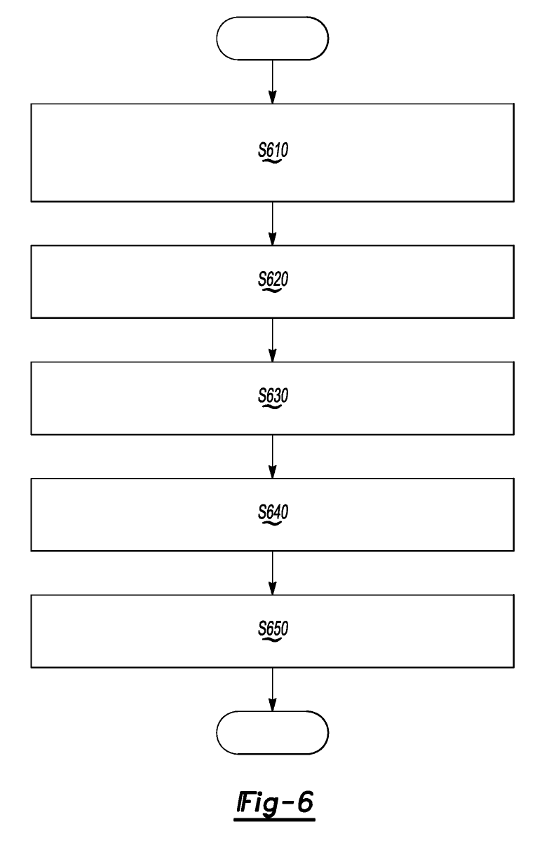

FIG. 6 shows a flowchart for a method for authenticating an application according to an exemplary embodiment. The method of FIG. 6 may be performed by the apparatus that authenticates an application 100 or may be encoded into a computer readable medium as instructions that are executable by a computer to perform the method.

Referring to FIG. 6 and operation 610, an authentication application on the first device connects to a second application of a second device on a second address and port in response to receiving a request on a first address and port from the second application. In operation 620, a request including a signed certificate of the second device is received. Then, in operation 630, it is determined whether the signed certificate is valid. In response to determining the signed certificate is valid, a screen to accept the request is displayed in operation 5650 if the signed certificate is unapproved. In operation 640, a function is performed if the request is accepted.

The processes, methods, or algorithms disclosed herein can be deliverable to/implemented by a processing device, controller, or computer, which can include any existing programmable electronic control device or dedicated electronic control device. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

One or more exemplary embodiments have been described above with reference to the drawings. The exemplary embodiments described above should be considered in a descriptive sense only and not for purposes of limitation. Moreover, the exemplary embodiments may be modified without departing from the spirit and scope of the inventive concept, which is defined by the following claims.

What is claimed is:

1. A method for authenticating an application, the method comprising:
detecting an input to enter an enrollment mode on a first device and entering into enrollment mode for a predetermined period of time;
during the predetermined period of time, connecting an authentication application on the first device to a second application of a second device on a second address and port in response to receiving a first request on a first address and port from the second application;
receiving a second request including a signed certificate of the second device;
determining whether the signed certificate is valid;
in response to determining the signed certificate is valid, displaying a screen to accept request if the signed certificate is unapproved; and
storing request if the request is accepted.

2. The method of claim 1, wherein the second request including the signed certificate comprises one or more from among user identification information, application identification information, a requested service name, a requested service port, a certificate of the second device, and a public key of the second device.

3. The method of claim 1, wherein the connecting the authentication application on the first device to the second application of the second device on the second address and port in response to receiving the first request on the first address and port from the second application comprises responding to the request by providing the second address and port to the second application.

4. The method of claim 1, wherein the first request on the first address and port from the second application comprises a multicast domain name system (mDNS) request, and
wherein the first address and port comprises a UDP rate limited port.

5. The method of claim 1, wherein the second address and port comprises a TCP rate limited port.

6. The method of claim 1, wherein the screen to accept the request includes a first option to always accept a connection from the second application, a second option to accept a connection from the second application for the received request, and a third option to deny a connection from the second application for the received request.

7. A method for authenticating an application, the method comprising:
connecting an authentication application on a first device to a second application of a second device on a second address and port in response to receiving a first request on a first address and port from the second application;
receiving a second request including a signed certificate of the second device;
determining whether the signed certificate is valid;
in response to determining the signed certificate is valid, displaying a screen to accept request if the signed certificate is unapproved;
sending a first encrypted random number and a second encrypted random number to the first application on the first device and the second application on the second device;
receiving, by the authentication application, a first hash of the decrypted first random number and a first shared predefined context string;
verifying the received first hash at the authentication application; and
closing a firewall sync port if the verifying the received first hash fails or opening a requested TLS port if the verifying the received first hash is successful.

8. The method of claim 7, further comprising:
receiving, by the first application, a second hash of the second decrypted random number and a second shared predefined context string;
verifying the second hash at the first application; and
setting up a TLS PSK based on the verified second hash and the second random number.

9. The method of claim 7, wherein the second request including the signed certificate comprises one or more from among user identification information, application identification information, a requested service name, a requested service port, a certificate of the second device, and a public key of the second device.

10. The method of claim 7, wherein the first request on the first address and port from the second application comprises and a multicast domain name system (mDNS) request, and
wherein the first address and port comprises a UDP rate limited port and the second address and port comprises a TCP rate limited port.

11. The method of claim 7, wherein the connecting the authentication application on the first device to the second application of the second device on the second address and port in response to receiving the request on the first address and port from the second application comprises responding to the request by providing the second address and port to the second application.

12. The method of claim 7, wherein the screen to accept the request includes a first option to always accept a connection from the second application, a second option to accept a connection from the second application for the received request, and a third option to deny a connection from the second application for the received request.

13. An apparatus that authenticates an application, the apparatus comprising:
at least one memory comprising computer executable instructions; and
at least one processor configured to read and execute the computer executable instructions, the computer executable instructions causing the at least one processor to:
connect an authentication application on a first device to a second application of a second device on a second address and port in response to receiving a first request on a first address and port from the second application;
receive a second request including a signed certificate of the second device;
determine whether the signed certificate is valid;
in response to determining the signed certificate is valid, display a screen to accept request if the signed certificate is unapproved; and
perform a function if the request is accepted.

14. The apparatus of claim 13, wherein the computer executable instructions cause the at least one processor to perform the function if the request is accepted by storing the request.

15. The apparatus of claim 13, wherein the computer executable instructions cause the at least one processor to perform the function if the request is accepted by:
sending a first encrypted random number and a second encrypted random number to the first application on the first device and the second application on the second device;
receiving, by the authentication application, a first hash of the decrypted first random number and a first shared predefined context string;
verifying the received first hash at the authentication application; and
closing a firewall sync port if the verifying the received first hash fails or opening a requested TLS port if the verifying the received first hash is successful.

16. The apparatus of claim 15, wherein the computer executable instructions cause the at least one processor to perform the function if the request is accepted by:
receiving, by the first application, a second hash of the second decrypted random number and a second shared predefined context string;
verifying the second hash at the first application; and
setting up a TLS PSK based on the verified second hash and the second random number.

17. The apparatus of claim 13, wherein the request including the signed certificate comprises one or more from among user identification information, application identification information, a requested service name, a requested service port, a certificate of the second device, and a public key of the second device.

18. The apparatus of claim 13, wherein the computer executable instructions cause the at least one processor to connect the authentication application on the first device to the second application of the second device on the second address and port in response to receiving the request on the first address and port from the second application by responding to the request by providing the second address and port to the second application.

19. The apparatus of claim 13, wherein the screen to accept the request includes a first option to always accept a connection from the second application, a second option to accept a connection from the second application for the received request, and a third option to deny a connection from the second application for the received request.

20. The apparatus of claim 13, wherein the request on the first address and port from the second application comprises a multicast domain name system (mDNS) request, and
wherein the first address and port comprises a UDP rate limited port and the second address and port comprises a TCP rate limited port.
